(19) United States
(12) Patent Application Publication
(10) Pub. No.: US 2020/0342304 A1
(43) Pub. Date: Oct. 29, 2020

(54) FEATURE IMPORTANCE IDENTIFICATION IN DEEP LEARNING MODELS

(71) Applicant: INTERNATIONAL BUSINESS MACHINES CORPORATION, ARMONK, NY (US)

(72) Inventors: Linsong Chu, White Plains, NY (US); Ramya Raghavendra, New York, NY (US); Catherine H. Crawford, Bedford, NH (US); MUDHAKAR SRIVATSA, White Plains, NY (US)

(21) Appl. No.: 16/394,006

(22) Filed: Apr. 25, 2019

(51) Int. Cl. G06N 3/08; G06N 5/02

(52) U.S. Cl. CPC G06N 3/08; G06N 5/02

(57) ABSTRACT

A method, computer system, and a computer program product for identifying feature importance in deep learning models is provided. Embodiments of the present invention may include building a reconstruction model. Embodiments of the present invention may include intercepting an output of a trained prediction model at a bottleneck layer. Embodiments of the present invention may include processing the output of the trained model using the reconstruction model. Embodiments of the present invention may include identifying a plurality of features based on the reconstruction model.

### STATEMENT REGARDING FEDERALLY SPONSORED RESEARCH OR DEVELOPMENT

This invention was made with government support under W911NF-16-3-0001 awarded by the Army Research Office (ARO). The government has certain rights to this invention.

### BACKGROUND

The present invention relates generally to the field of computing, and more particularly to deep learning. Deep learning models may be challenged by producing results that may not be well explained. The unexplained results may be known as black-box results. Black-box results include the inability to identify and explain how various features may affect outcomes in a neural network. Resolving deep learning classification or regression issues by the identification of important variables or features that led to a conclusion may be explored.

### SUMMARY

Embodiments of the present invention disclose a method, computer system, and a computer program product for identifying feature importance in deep learning models. Embodiments of the present invention may include building a reconstruction model. Embodiments of the present invention may include intercepting an output of a trained prediction model at a bottleneck layer. Embodiments of the present invention may include processing the output of the trained model using the reconstruction model. Embodiments of the present invention may include identifying a plurality of features based on the reconstruction model.

### BRIEF DESCRIPTION OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to at least one embodiment;

FIG. 2 is an operational flowchart illustrating a process for identifying feature importance in a deep learning model according to at least one embodiment;

FIG. 3 is a block diagram of internal and external components of computers and servers depicted in FIG. 1 according to at least one embodiment;

FIG. 4 is a block diagram of an illustrative cloud computing environment including the computer system depicted in FIG. 1, in accordance with an embodiment of the present disclosure; and

FIG. 5 is a block diagram of functional layers of the illustrative cloud computing environment of FIG. 4, in accordance with an embodiment of the present disclosure.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

As previously described, deep learning models may be challenged by producing results that may not be well explained. The unexplained results may be known as black-box results. Black-box results include the inability to identify and explain how various features may affect outcomes in a neural network. Resolving deep learning classification or regression issues by the identification of important variables or features that lead to a conclusion may be explored. Typically, identifying variable importance has been accomplished though gradient computation, however, gradient computation may be calculated using a large amount of resources at a high cost. Therefore, it may be advantageous to, among other things, identify a new process to identify the importance of features for deep learning in a neural network.

Deep learning is a type of machine learning that may classify information based on the input data or training data. Input data may consist of structured data or unstructured data. Structured data may include data that is highly organized, such as a spreadsheet, relational database or data that is stored in a fixed field. Unstructured data may include data that is not organized and has an unconventional internal structure, such as a portable document format (PDF), an image, a presentation, a webpage, video content, audio content, an email, a word processing document or multimedia content. Deep learning may also be related to or known as hierarchical learning or deep structured learning.

Deep learning may map an input, classify data, interpret datasets and provide an output of data for one or more layers of data. Each layer of data may be represented as a node. A node may also be known as a neuron or an artificial neuron. Deep learning may detect similarities in data that may or may not be labeled. For example, deep learning may operate as supervised learning, unsupervised learning or semi-supervised learning. Supervised learning may use a labeled dataset to train a deep learning model. Unsupervised learning may use all unlabeled data to train a deep learning model. Semi-supervised learning may use both labeled datasets and unlabeled datasets to train a deep learning model. The deep learning models may provide, for example, a graph output that may be generated as nodes and edges relating to the domain specific taxonomy that is being learned.

The following described exemplary embodiments provide a system, method and program product for deep learning feature identification. As such, embodiments of the present invention have the capacity to improve the technical field of deep learning by identifying and analyzing feature importance by reducing or eliminating the black box results in order to better understand model behavior. More specifically, an analysis of a deep learning model will be evaluated at the bottleneck layer. The bottleneck layer will be used to identify feature importance by introducing convolutional spatial embedding to convert data with spatial information into spatial images that are suitable for convolutional neural networks.

This approach brings advantages, such as identifying highly correlated input features such that removing an important feature will not increase a loss of data. If more than one feature is highly correlated, and if one of the two features is removed, the result may not be affected or may be affected by a nominal amount. An indication of two features that are highly correlated may include two features that have a similar reconstruction error value. Another advantage of the present embodiment includes a model that examines all features in unison and then compares the reconstruction errors to enable accurate feature selection decisions.

According to at least one embodiment, feature importance may be analyzed by adding a reconstruction decoder to a bottleneck layer in an existing neural network. The reconstruction decoder may compute a reconstruction error value. A bottleneck layer may include a layer that contains a smaller number of nodes than one or more of the previous layers. Any layer in, for example, a neural network, may be used for reconstructing the input data, however, the bottleneck layer may be used for information reconstruction obtained from a smaller number of nodes or neurons. The nodes at the bottleneck layer may be used to identify important data features and unimportant data features in a trained model by computing a reconstruction error value. The term bottleneck layer may also be known as an information bottleneck or a bottleneck. The term model may be used to indicate various types of machine learning models, such as a deep learning model, a neural network model, a trained model, an attention-based model, a classification model, a regression model or a decision tree model. A deep learning model may be used for example purposes for the bottleneck reconstruction program.

A model that encounters a bottleneck layer may retain an encoded representation of the input. For example, when a model goes through an information bottleneck, such as an encoder-decoder model, the best-encoded representation of the input for the target is retained. Input parameters, such as input data from one or more domains, may be related to a target function, such as a desired output that is related to the one or more domains. Upon reconstruction of the bottleneck layer, feature importance may be inferred based on the quality level that each feature is reconstructed. A reconstruction decoder model may be trained to reconstruct the bottleneck layer. When a bottleneck occurs in a model, important features may be preserved while less important features may be identified as less important, thus, the less important features may not be preserved. Important features may be identified by a lower reconstruction error value associated with the feature and less important features may be identified by having a higher reconstruction error value associated with the feature. The important features that are preserved during a bottleneck may be reconstructed with a higher accuracy and a higher quality than less important features.

According to an embodiment, spatial embedding may be applied to spatial data in a deep encoder-decoder pipeline. A deep encoder-decoder pipeline may also be known as an encoder-decoder pipeline or a training pipeline. Various types of data may be used in the training pipeline. Spatial data may be a use case example in the present embodiment and may include data that corresponds to geographic information. Spatial embedding may be considered a process that converts data, such as spatial data that contains spatial information, into spatial images. A spatial image may also be known as a tensor or a multi-linear geometric vector mapping. A spatial image may be created by dividing a specified region, such as a region of interest, into grids. Each grid may be defined using a hash code, such as a geohash. A geohash may identify a specific location based on an alphanumeric string, such as a latitude and a longitude. Each pixel in the spatial image may correspond to a geohash of a specified bit depth. The non-spatial features may also be assigned as pixel values. A non-spatial feature may include, for example, a time of day or a day of the week.

Using spatial embedding, spatial data and non-spatial data may be converted into an image. Spatial information is encoded as an image layout and non-spatial information is encoded as pixel values or image channels. The produced spatial image may fully capture underlying spatial information within the input data or within the data obtained from the bottleneck layer by using a convolutional neural network (CNN). The CNN may be trained to predict the target data by using input features. CNNs may be used to analyze images and may require minimal processing by assigning importance levels, such as weights and biases, to images.

According to an embodiment, a spatio-temporal embedding may be applied to both spatial data and temporal data in a deep encoder-decoder pipeline. The spatio-temporal embedding may capture both spatial information and temporal information, such as data that is acquired from a sequence of images, such as weather data obtained for a year may be represented by 365 daily images, or 730 bi-daily images. The pipeline data may be leveraged using a recurrent neural network (RNN) to capture the temporal data followed by the CNN to capture the spatial data. A RNN is a network that may process temporal data to produces a directed graph in a temporal sequence.

The convolutional spatial embedding may be meaningful for determining how input data may affect target data. For example, if weather data is used as input data and traffic data is used as target data, the convolutional spatial embedding may assist in the determination of how weather may affect traffic since traffic in one location may be affected by a weather condition in the same neighborhood and also may be affected by a weather condition in a neighboring area. Spatial embedding may capture spatial dependencies through convolutional operations and the identified spatial dependencies may improve the accuracy of predictions over methods that may monitor local data only. An advantage of using spatial embedding to transform data with spatial information into spatial images may include determining and capturing the spatial dependencies of the input data using a CNN or convolutional operations. Spatial embedding may be meaningful for target data, such as traffic data. Traffic data may be encoded in a single channel image where each pixel value corresponds to a traffic congestion value in the pixel, such as a geohash.

According to an embodiment, the network architecture may be constructed such that data may flow along two different paths. One path may include a prediction path which may follow an encoder-decoder structure in which data goes from input data to target data. The target may be predicted based on the training model. The other path may include a feature reconstruction path which may include a decoder that goes from trained encoded data to reconstructed input data. The trained encoded data may be the output from the bottleneck layer.

Feature importance detection may occur at the bottleneck layer by obtaining data from the bottleneck layer of a pre-built deep learning model. The output from a trained model may be intercepted at the trained model bottleneck layer and then hash codes may be computed. The hash codes may train a decoder to map the hash code to an original input. Feature reconstruction errors produced by the decoder may be used to rank the importance of the input features. The reconstruction error may be known as the error or the decoding error. Feature importance may be identified such that the smaller the reconstruction error value, the larger the sensitivity or importance of the input feature. The higher the reconstruction error is, the less importance may be assigned to the feature.

The prediction path and the feature reconstruction path may operate sequentially, simultaneously or in parallel. The encoder-decoder may be trained using the input data and the target data. Once the encoder-decoder is trained, the encoded data may be extracted and fed into a different decoder, such as a feature reconstruction decoder. The feature reconstruction decoder may reconstruct the encoded data back to the original input. A reconstruction error value may be determined for each feature and the reconstruction error value may be used as a proxy for feature importance.

According to an embodiment, two datasets may be used during evaluation. For example, dataset A is the input data and dataset B is the target data. A user of the bottleneck reconstruction program may want to evaluate or predict which dataset A features are optimal or important for predicting dataset B. Dataset A has, for example, 10 features and each feature has a historical average value that is normalized by a z-score. The z-score is a standard deviation measurement. The z-score may be represented on a normal distribution curve and the deviations that are to the left of the −3 on the distribution curve or to the right of +3 on the distribution curve may be considered anomalies or outliers. Dataset B may also be normalized. Both dataset A and dataset B may be transformed into spatial images using spatial embedding. A spatial image may be generated for each dataset. The input dataset A may differ from the target dataset B data in order to analyze the feature importance of the input dataset A and to evaluate how the feature importance of dataset A may affect dataset B.

The prediction path may be built using a convolutional encoder-decoder, using two inception blocks as the encoder and two transposed convolution layers as the decoder. The two inception blocks may determine or define a convolution kernel size. For example, the encoder determines the size of the area of dataset A that should be attributed to dataset B. After two inception blocks, the encode image (i.e., bottleneck layer) may have a similar height and width after padding and image adjustments. The prediction path decoder structure may be the same as or similar to the feature reconstruction path decoder. One variance between the prediction path decoder and the feature reconstruction path decoder may include changing the number of neurons in each layer of the prediction path decoder such that each layer may reconstruct to the correct number of channels.

The bottleneck reconstruction program may analyze an input dataset with a target dataset for various domains and industries. For instance, weather data may be used to train, encode, decode and reconstruct the weather data as spatial images while using traffic data as the target data. The input dataset may include weather data and the target dataset may include traffic data. The input dataset and the target dataset may also be used from other domains, such as a turbine and engine fault assessment, a defect detection in semiconductor chips, industrial IoT pipelines for quality assessment for manufacturing cars. Other domain or industry related data that may be used to evaluate feature importance may include industries such as business, travel, technology, finance, medical, government, legal, automotive, industrial, agricultural or construction.

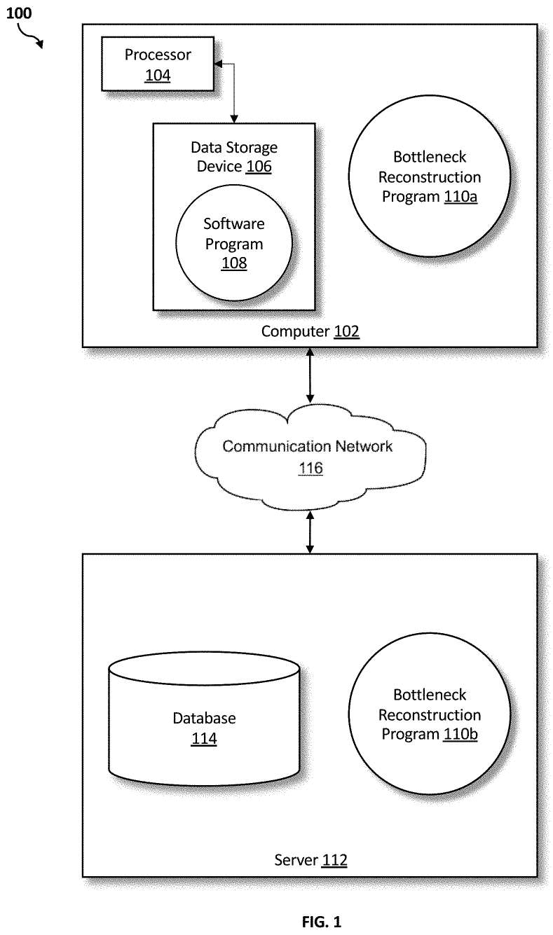

Referring to FIG. 1, an exemplary networked computer environment 100 in accordance with one embodiment is depicted. The networked computer environment 100 may include a computer 102 with a processor 104 and a data storage device 106 that is enabled to run a software program 108 and a bottleneck reconstruction program 110a. The networked computer environment 100 may also include a server 112 that is enabled to run a bottleneck reconstruction program 110b that may interact with a database 114 and a communication network 116. The networked computer environment 100 may include a plurality of computers 102 and servers 112, only one of which is shown. The communication network 116 may include various types of communication networks, such as a wide area network (WAN), local area network (LAN), a telecommunication network, a wireless network, a public switched network and/or a satellite network. It should be appreciated that FIG. 1 provides only an illustration of one implementation and does not imply any limitations with regard to the environments in which different embodiments may be implemented. Many modifications to the depicted environments may be made based on design and implementation requirements.

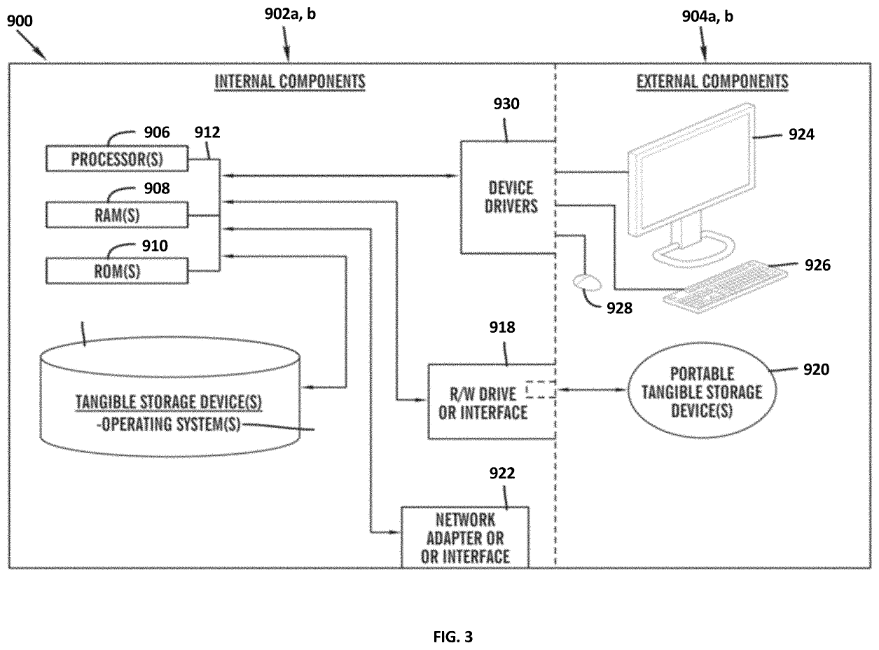

The client computer 102 may communicate with the server computer 112 via the communications network 116. The communications network 116 may include connections, such as wire, wireless communication links, or fiber optic cables. As will be discussed with reference to FIG. 3, server computer 112 may include internal components 902a and external components 904a, respectively, and client computer 102 may include internal components 902b and external components 904b, respectively. Server computer 112 may also operate in a cloud computing service model, such as Software as a Service (SaaS), Analytics as a Service (AaaS), Platform as a Service (PaaS), or Infrastructure as a Service (IaaS). Server 112 may also be located in a cloud computing deployment model, such as a private cloud, community cloud, public cloud, or hybrid cloud. Client computer 102 may be, for example, a mobile device, a telephone, a personal digital assistant, a netbook, a laptop computer, a tablet computer, a desktop computer, or any type of computing devices capable of running a program, accessing a network, and accessing a database 114. According to various implementations of the present embodiment, the bottleneck reconstruction program 110a, 110b may interact with a database 114 that may be embedded in various storage devices, such as, but not limited to a computer/mobile device 102, a networked server 112, or a cloud storage service.

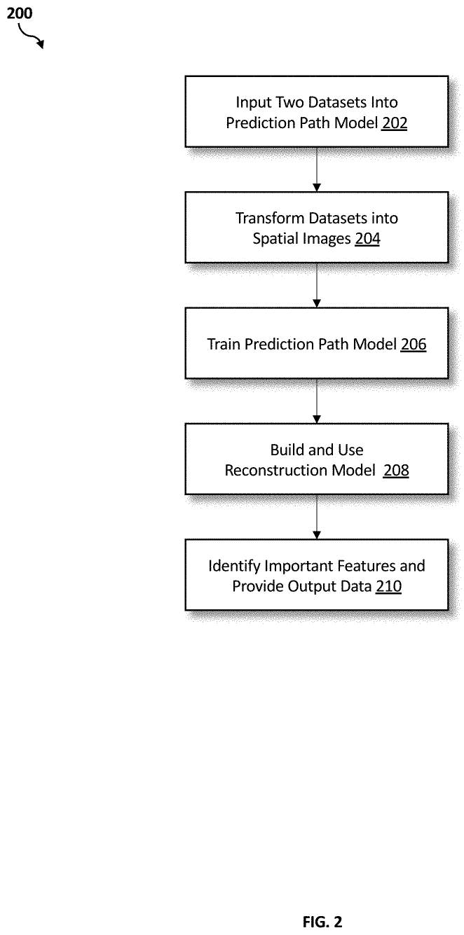

According to the present embodiment, a user using a client computer 102 or a server computer 112 may use the bottleneck reconstruction program 110a, 110b (respectively) to identify important features in a deep learning model. The bottleneck reconstruction method is explained in more detail below with respect to FIG. 2.

Referring now to FIG. 2, an operational flowchart illustrating the exemplary deep learning model feature importance process 200 used by the bottleneck reconstruction program 110a, 110b according to at least one embodiment is depicted.

As a running example, weather data and traffic data may be used to analyze which weather features may affect traffic. An analysis of how good weather conditions or adverse weather conditions may predict driving conditions or impact driving conditions and potentially create a traffic bottleneck on the road. The analyses may be used to offer data to a user or a client pertaining to how a feature may affect an alternate dataset, such as how weather features may affect traffic for a particular location and the surrounding locations and which weather features may affect traffic. This is only one example for the bottleneck reconstruction program 110a, 110b. Various domain data or various industry data may be used as datasets for identifying feature importance.

At 202, two datasets are entered into a prediction path model. One dataset is an input dataset and the other dataset is a target dataset. For example, the input dataset may include weather data and the target dataset may include traffic data. The weather data includes features such as temperature, humidity, rain, snow, wind, dew point, precipitation, freezing rain or condensation. Each feature may have a historical hourly average associated with the feature. The features may be accessible to the public and stored on a public database. The traffic data may include road segments and corresponding vehicle speeds. If a different domain is used that stores data used in a dataset from a private or an encrypted database, such as a medical industry, then proper access may be obtained for the use of the data or the client may be, for example, a medical facility.

As an example, 24 weather features will be used. Each weather features may be normalized by a z-score and the values may be clipped to [−3, 3] in order to avoid outliers. Extra indicator features or binary features may be generated for rain and snow related features. Traffic data may be normalized from major roads and traffic congestion may be defined as a road speed normalized by a road reference speed that may be computed as a target. For example, normalized traffic data obtained from a functional road class (FRC) with types 0-2 representing. The FRC may include functional road classifications, such as arterial roads, collector road and local roads.

At 204, the two datasets are transformed into spatial images. The input dataset and the target dataset may be transformed into spatial images using a spatial embedding. The transformation to spatial images may allow the datasets to conform to or fit in a convolutional encoder-decoder. Spatial embedding may use a geohash as image pixels. For example, a 25 bitdepth (i.e., a 5 digit base-32 precision) geohash may be constructed as pixels when creating spatial images for weather data and for traffic data.

For weather data, a weighted average may be used to compute weather features for each geohash. For traffic data, each projected road segment may correspond to one or more geohashes and each projected road segment may have a weight congestion value associated for each geohash. Some geohashes may not have any major corresponding roads and thus may not have traffic data available. The pixels for geohashes with no available traffic data may be assigned a value of −1 and assigned 0 weights during network training. The assigned value of −1 and the assigned 0 weight may prevent the neural network from learning on the pixel regions that do not have available data associated to the pixel.

Features may be used as image channels. Each local feature value may be converted to one dimension of the pixel value, thus, each feature may become one channel of the spatial image. Using the example of 24 weather features, the transformation creates 24 channels for weather images. For traffic data, using an example of traffic congestion, the transformation creates one channel for the traffic images. As an example, the area of interest is divided into 17×18 geohashes and the divided area of interest creates a shape of spatial images of 17×18. Using spatial embedding for the input datasets, 8760 weather images were generated by hourly images taken over 365 days (i.e., 365 days×24 hours) for a specified city. Two tensors may be created for the neural network. One tensor has a shape (8760, 17, 18, 24) for weather data and the other tensor has a shape (8760, 17, 18, 1) for traffic data.

At 206, the prediction path model is trained. The prediction path model may consist of an encoder structure and a decoder structure. One or more datasets, images or spatial images may be input into the prediction path model. The prediction path model may be built using a convolutional encoder-decoder. One or more inception blocks may be used as an encoder and one or more transposed convolutional layers may be used as a decoder.

As an ideal example, two inception blocks may be used as the encoder and two transposed convolutional layers are used as the decoder. For the encoder, the kernel size may define the size of the area that may be attributed to the target condition. For example, the kernel size defines the weather condition as it relates to how large of an area should be attributed to the traffic condition in the current area. The neural network may learn the hyper-parameters as opposed to a user setting the parameters and defining the convolution kernel size. For example, the prediction path model encoder defines kernel sizes of 1, 3 and 5 for the first inception block and kernel sizes 3 and 7 for the second inception block. Both inception blocks may provide proper or optimal padding to adjust the image height and image width. Once the images are encoded by the two inception blocks, the encoding may produce a bottleneck layer of a certain height and width, such as a height of 8 and a width of 8.

The decoder of the prediction path model, using two transposed convolutional layers, may include the first layer using a 2×2 kernel with a stride 2 and a second layer using a 2×3 kernel with a stride 1. The stride may be considered padding or a shift in pixels over a matrix. Once the prediction path model is trained, the data at the bottleneck layer may be available to be used, obtained or intercepted for further evaluation.

At 208, the reconstruction model is built and used. The reconstruction model may be built and utilized to reconstruct or decode features in order to identify important features. The bottleneck layer data may be intercepted and used as an input for the reconstruction model. The reconstruction model may be built using a convolution decoder, for example a decoder that is similar to the prediction path decoder that includes two transposed convolutional layers. The reconstruction model may, for example, be distinguished from the prediction path decoder by changing the number of neurons in each layer to make the decoder reconstruct to the correct number of channels. A correct number of channels may be represented by the number of channels that were in the input image, for example, if the 4 weather channels of rain, snow, temperature and wind were input into the prediction path decoder, then the reconstruction model may reconstruct the 4 channels. The reconstruction model may not be limited to reconstructing the exact number of channels to optimally operate and may also reconstruct a different number of channels as the input image.

Reconstruction error results may provide an identification of important features determined by a given dataset input or output result. Feature importance in the reconstruction model may be identified by using a per-channel normalized reconstruction error as a proxy. After a feature reconstruction path is trained in the reconstruction model, all data may be passed back through the feature reconstruction path to get the reconstructed dataset images, for example, the reconstructed weather images. All data may include, for example, the data that may be used to predict an outcome and to identify important features that resulted in the predicted outcome. A per-channel root mean square error (RMSE) may be calculated between the reconstructed dataset images and the raw dataset data. For example, the RMSE is calculated between the weather images and the raw weather images in order to reconstruct the input from the bottleneck layer. A per-channel RMSE baseline may be calculated for each dataset feature (e.g., weather feature) as if each channel is being reconstructed to the channel's mean value. The raw distribution of the input features (e.g., dataset features or weather features) may be the same or they may be different. If the RMSE in a feature is low, it indicates that the feature is important. If the RMSE in a feature is high, it indicates that the feature is less important. The raw RMSE value may be used or the baselined RMSE value may be used.

An alternate example may use a decision tree model output for the reconstruction model. The decision tree may provide an outcome by following a path from a root to a leaf. The leaf may correspond to a n-dimensional box and the input features are in terms of dimensions. The centroid of the box may be treated as an output on the bottleneck layer with which the decoder may be trained. Assigning reconstruction errors and assessing feature importance may be the same process.

At 210, the important features are identified, and output data is provided. Important features or features of interest may be ranked based on the normalized per-channel reconstruction error. The normalized per-channel reconstruction error may be calculated by normalizing the per-channel RMSE by the baseline RMSE. If a feature is reconstructed with a smaller loss value, the feature may have a higher importance value since the information may be preserved in the encoded data during the prediction path.

Continuing from the previous example, and assuming the features were normalized with a z-score during the data preprocessing, the baseline per-channel RMSE is 1 which may create a raw reconstruction error that is the same as the normalized reconstruction error. An example of the reconstruction error for some of the features are displayed in Table 1 below.

TABLE 1

| Feature | Reconstruction Error |
|---|---|
| Temperature (z-score) | 0.00462615 |
| Temperature Feels Like (z-score) | 0.00538474 |
| Temperature Change 24 Hours (z-score) | 0.01004373 |
| Wind Speed (z-score) | 0.01443422 |
| Pressure Change (z-score) | 0.03341724 |

The features that display the smaller loss values may be the features of higher importance. From Table 1, the results may show that the temperature feature is the most important feature and the temperature feels like feature is almost equally as important to the temperature feature. The next feature of importance is the temperature change in 24 hours feature followed by the wind speed feature. The least important feature listed in Table 1 is the pressure change feature.

One other observation of the features in Table 1 may include the observation that the temperature feature and the temperature feels like feature are highly correlated features and both have a very similar reconstruction error. Therefore, highly correlated features may receive similar feature importance which may be a desired result. The desired result may provide advantages since the model performance may not be affected if noise is added or dropped to the temperature feature. Noise may include a distortion of data, such as altering the quality of the image. Additionally, since the temperature feels like feature is similar, this feature may act as the temperature feature if the temperature feature gets skewed.

The data provided by Table 1 may be an example output result that a client may have access to via a computing device. Alternate outputs may include an analysis for a user or for a client as to which features are important. For example, an analysis of Table 1 may be provided to a user in the form of a message on a computing device informing the user that the temperature feature is the most important feature since the temperature feature has the lowest reconstruction error value.

It may be appreciated that FIG. 2 provides only an illustration of one embodiment and does not imply any limitations with regard to how different embodiments may be implemented. Many modifications to the depicted embodiment(s) may be made based on design and implementation requirements.

FIG. 3 is a block diagram 900 of internal and external components of computers depicted in FIG. 1 in accordance with an illustrative embodiment of the present invention. It should be appreciated that FIG. 3 provides only an illustration of one implementation and does not imply any limitations with regard to the environments in which different embodiments may be implemented. Many modifications to the depicted environments may be made based on design and implementation requirements.

Data processing system 902, 904 is representative of any electronic device capable of executing machine-readable program instructions. Data processing system 902, 904 may be representative of a smart phone, a computer system, PDA, or other electronic devices. Examples of computing systems, environments, and/or configurations that may represented by data processing system 902, 904 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 and network server 112 may include respective sets of internal components 902 a, b and external components 904 a, b illustrated in FIG. 3. Each of the sets of internal components 902 a, b includes one or more processors 906, one or more computer-readable RAMs 908 and one or more computer-readable ROMs 910 on one or more buses 912, and one or more operating systems 914 and one or more computer-readable tangible storage devices 916. The one or more operating systems 914, the software program 108, and the bottleneck reconstruction program 110a in client computer 102, and the bottleneck reconstruction program 110b in network server 112, may be stored on one or more computer-readable tangible storage devices 916 for execution by one or more processors 906 via one or more RAMs 908 (which typically include cache memory). In the embodiment illustrated in FIG. 3, each of the computer-readable tangible storage devices 916 is a magnetic disk storage device of an internal hard drive. Alternatively, each of the computer-readable tangible storage devices 916 is a semiconductor storage device such as ROM 910, EPROM, flash memory or any other computer-readable tangible storage device that can store a computer program and digital information.

Each set of internal components 902 a, b also includes a R/W drive or interface 918 to read from and write to one or more portable computer-readable tangible storage devices 920 such as a CD-ROM, DVD, memory stick, magnetic tape, magnetic disk, optical disk or semiconductor storage device. A software program, such as the software program 108 and the bottleneck reconstruction program 110a, 110b can be stored on one or more of the respective portable computer-readable tangible storage devices 920, read via the respective R/W drive or interface 918 and loaded into the respective hard drive 916.

Each set of internal components 902 a, b may also include network adapters (or switch port cards) or interfaces 922 such as a TCP/IP adapter cards, wireless wi-fi interface cards, or 3G or 4G wireless interface cards or other wired or wireless communication links. The software program 108 and the bottleneck reconstruction program 110a in client computer 102 and the bottleneck reconstruction program 110b in network server computer 112 can be downloaded from an external computer (e.g., server) via a network (for example, the Internet, a local area network or other, wide area network) and respective network adapters or interfaces 922. From the network adapters (or switch port adaptors) or interfaces 922, the software program 108 and the bottleneck reconstruction program 110a in client computer 102 and the bottleneck reconstruction program 110b in network server computer 112 are loaded into the respective hard drive 916. The network may comprise copper wires, optical fibers, wireless transmission, routers, firewalls, switches, gateway computers and/or edge servers.

Each of the sets of external components 904 a, b can include a computer display monitor 924, a keyboard 926, and a computer mouse 928. External components 904 a, b can also include touch screens, virtual keyboards, touch pads, pointing devices, and other human interface devices. Each of the sets of internal components 902 a, b also includes device drivers 930 to interface to computer display monitor 924, keyboard 926 and computer mouse 928. The device drivers 930, R/W drive or interface 918 and network adapter or interface 922 comprise hardware and software (stored in storage device 916 and/or ROM 910).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure or on a hybrid cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Analytics as a Service (AaaS): the capability provided to the consumer is to use web-based or cloud-based networks (i.e., infrastructure) to access an analytics platform. Analytics platforms may include access to analytics software resources or may include access to relevant databases, corpora, servers, operating systems or storage. The consumer does not manage or control the underlying web-based or cloud-based infrastructure including databases, corpora, servers, operating systems or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

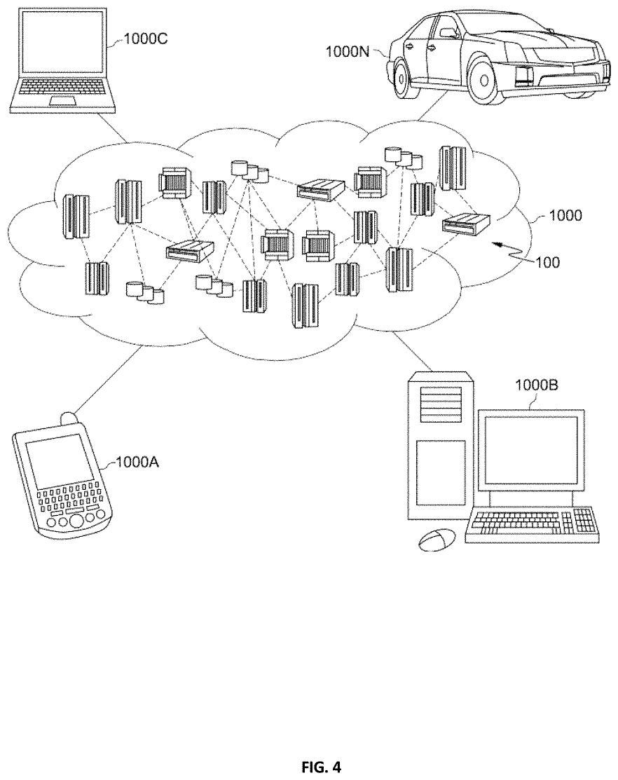

Referring now to FIG. 4, illustrative cloud computing environment 1000 is depicted. As shown, cloud computing environment 1000 comprises one or more cloud computing nodes 100 with which local computing devices used by cloud consumers, such as, for example, personal digital assistant (PDA) or cellular telephone 1000A, desktop computer 1000B, laptop computer 1000C, and/or automobile computer system 1000N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 1000 to offer infrastructure, platforms and/or software as services for which a cloud consumer does not need to maintain resources on a local computing device. It is understood that the types of computing devices 1000A-N shown in FIG. 4 are intended to be illustrative only and that computing nodes 100 and cloud computing environment 1000 can communicate with any type of computerized device over any type of network and/or network addressable connection (e.g., using a web browser).

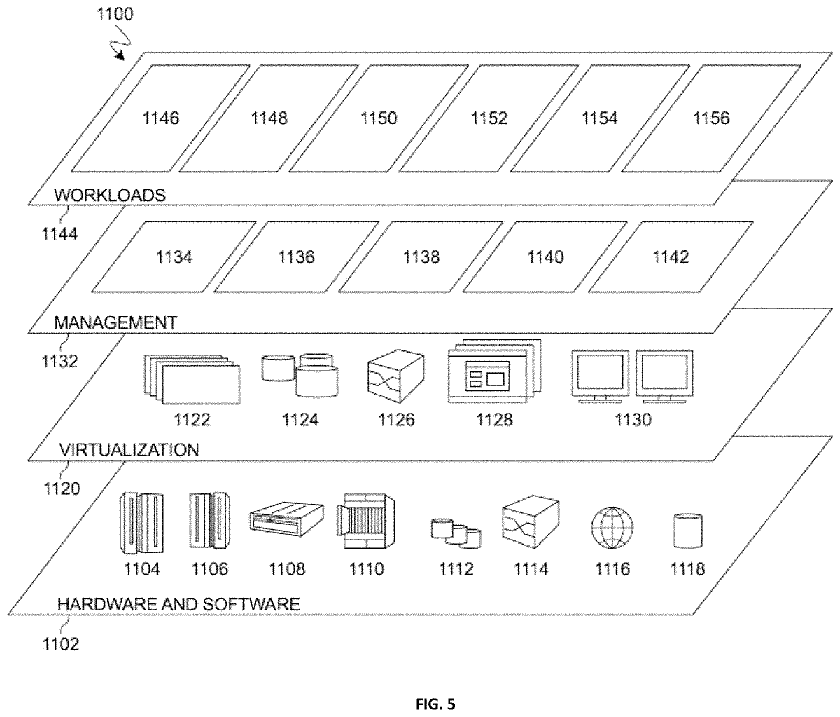

Referring now to FIG. 5, a set of functional abstraction layers 1100 provided by cloud computing environment 1000 is shown. It should be understood in advance that the components, layers, and functions shown in FIG. 5 are intended to be illustrative only and embodiments of the invention are not limited thereto. As depicted, the following layers and corresponding functions are provided:

Hardware and software layer 1102 includes hardware and software components. Examples of hardware components include: mainframes 1104; RISC (Reduced Instruction Set Computer) architecture based servers 1106; servers 1108; blade servers 1110; storage devices 1112; and networks and networking components 1114. In some embodiments, software components include network application server software 1116 and database software 1118.

Virtualization layer 1120 provides an abstraction layer from which the following examples of virtual entities may be provided: virtual servers 1122; virtual storage 1124; virtual networks 1126, including virtual private networks; virtual applications and operating systems 1128; and virtual clients 1130.

In one example, management layer 1132 may provide the functions described below. Resource provisioning 1134 provides dynamic procurement of computing resources and other resources that are utilized to perform tasks within the cloud computing environment. Metering and Pricing 1136 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 1138 provides access to the cloud computing environment for consumers and system administrators. Service level management 1140 provides cloud computing resource allocation and management such that required service levels are met. Service Level Agreement (SLA) planning and fulfillment 1142 provide pre-arrangement for, and procurement of, cloud computing resources for which a future requirement is anticipated in accordance with an SLA.

Workloads layer 1144 provides examples of functionality for which the cloud computing environment may be utilized. Examples of workloads and functions which may be provided from this layer include: mapping and navigation 1146; software development and lifecycle management 1148; virtual classroom education delivery 1150; data analytics processing 1152; transaction processing 1154; and feature importance identification 1156. A bottleneck reconstruction program 110a, 110b provides a way to identify important features in machine learning models.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language, python programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for identifying feature importance in deep learning models, the method comprising:
building a reconstruction model;
intercepting an output of a trained prediction model at a bottleneck layer;
processing the output of the trained model using the reconstruction model; and
identifying a plurality of features based on the reconstruction model.

2. The method of claim 1, further comprising:
receiving two datasets;
transforming the two datasets into two sets of spatial images; and
training the prediction model using the two sets of spatial images.

3. The method of claim 1, wherein the reconstruction model is built using a convolution decoder, wherein the reconstruction model decodes the plurality of features by calculating a reconstruction error value.

4. The method of claim 1, wherein the plurality of features are identified using a reconstruction error value.

5. The method of claim 2, wherein the prediction model includes a prediction model encoder and a prediction model decoder, wherein the prediction model encoder includes one or more inception blocks and the prediction model decoder includes one or more transposed convolutional layers.

6. The method of claim 2, wherein the two datasets include an input dataset and a target dataset.

7. The method of claim 2, wherein a spatial embedding is used to transform the two datasets into the two sets of spatial images, wherein the two sets of spatial images allow the two datasets to conform to a convolutional encoder-decoder, wherein the spatial embedding uses geohashes as image pixels.

8. A computer system for identifying feature importance in deep learning models, comprising:
one or more processors, one or more computer-readable memories, one or more computer-readable tangible storage media, and program instructions stored on at least one of the one or more computer-readable tangible storage media for execution by at least one of the one or more processors via at least one of the one or more computer-readable memories, wherein the computer system is capable of performing a method comprising:
building a reconstruction model;
intercepting an output of a trained prediction model at a bottleneck layer;
processing the output of the trained model using the reconstruction model; and
identifying a plurality of features based on the reconstruction model.

9. The computer system of claim 8, further comprising:
receiving two datasets;
transforming the two datasets into two sets of spatial images; and
training the prediction model using the two sets of spatial images.

10. The computer system of claim 8, wherein the reconstruction model is built using a convolution decoder, wherein the reconstruction model decodes the plurality of features by calculating a reconstruction error value.

11. The computer system of claim 8, wherein the plurality of features are identified using a reconstruction error value.

12. The computer system of claim 9, wherein the prediction model includes a prediction model encoder and a prediction model decoder, wherein the prediction model encoder includes one or more inception blocks and the prediction model decoder includes one or more transposed convolutional layers.

13. The computer system of claim 9, wherein the two datasets include an input dataset and a target dataset.

14. The computer system of claim 9, wherein a spatial embedding is used to transform the two datasets into the two sets of spatial images, wherein the two sets of spatial images allow the two datasets to conform to a convolutional encoder-decoder, wherein the spatial embedding uses geohashes as image pixels.

15. A computer program product for identifying feature importance in deep learning models, comprising:
one or more computer-readable tangible storage media and program instructions stored on at least one of the one or more computer-readable tangible storage media, the program instructions executable by a processor to cause the processor to perform a method comprising:
building a reconstruction model;
intercepting an output of a trained prediction model at a bottleneck layer;
processing the output of the trained model using the reconstruction model; and
identifying a plurality of features based on the reconstruction model.

16. The computer program product of claim 15, further comprising:
receiving two datasets;
transforming the two datasets into two sets of spatial images; and
training the prediction model using the two sets of spatial images.

17. The computer program product of claim 15, wherein the reconstruction model is built using a convolution decoder, wherein the reconstruction model decodes the plurality of features by calculating a reconstruction error value.

18. The computer program product of claim 15, wherein the plurality of features are identified using a reconstruction error value.

19. The computer program product of claim 16, wherein the prediction model includes a prediction model encoder and a prediction model decoder, wherein the prediction model encoder includes one or more inception blocks and the prediction model decoder includes one or more transposed convolutional layers.

20. The computer program product of claim 16, wherein the two datasets include an input dataset and a target dataset.
